(19) United States
(12) Patent Application Publication
(10) Pub. No.: US 2018/0328311 A1
(43) Pub. Date: Nov. 15, 2018

(54) Heat Input Zone Of A Piston, Having A Groove Flank Positioned In Said Heat Input Zone

(71) Applicant: KS Kolbenschmidt GmbH, Neckarsulm (DE)

(72) Inventors: Jens Voigt, Heilbronn (DE); Johannes Spermann, Bad Wimpfen (DE)

(73) Assignees: KS Kolbenschmidt GmbH, Neckarsulm (DE); KS Kolbenschmidt GmbH, Neckarsulm (DE)

(21) Appl. No.: 15/773,318

(22) PCT Filed: Nov. 9, 2016
(86) PCT No.: PCT/EP2016/077037

§ 371 Date: May 3, 2018

(30) Foreign Application Priority Data
Nov. 9, 2015 (DE) 10 2015 222 009.5
Dec. 18, 2015 (DE) 10 2015 225 953.6

(51) Int. Cl. F02F 3/00; B23K 20/12; B21K 1/18

(52) U.S. Cl. CPC F02F 3/003; B23K 20/129; B23K 2101/003; F02F 2003/0061; B21K 1/185

(57) ABSTRACT

The invention relates to a piston of an internal combustion engine including at least one peripheral annular groove. The piston includes an upper part and a lower part permanently joined in the region of a joining plane by a friction welding method. The joining plane may be located between the upper flank and the lower flank of the annular groove. A heat-affected zone is generated due to the use of the friction welding and includes at least one of the upper flank or the lower flank of the annular groove. Where multiple annual grooves are used, the joining plane and heat-affected zone may be positioned on alternate annular grooves.

### TECHNICAL FIELD

The invention relates to a piston of an internal combustion engine, comprising an upper portion and a lower portion which are joined together in a non-releasable manner in the region of a joining plane by means of a friction welding method, wherein the piston has at least one peripheral annular groove.

### BACKGROUND

The invention is based on a piston, in particular a cooling channel piston, as known from DE 10 2010 033 881 A1.

The piston which is produced for subsequent operation is formed from an upper portion and a lower portion which are both connected to each other by means of friction welding. In the joining operation, there is produced an annularly closed cooling channel which is formed by the upper portion and the lower portion.

The upper portion and lower portion have joining faces which face each other and which are connected to each other by means of friction welding. In this instance, friction weld beads are produced in a manner known per se.

The cooling channel piston known from DE 10 2010 033 881 A1 has friction welding faces which are located concentrically one in the other, consequently two friction welding zones.

In the outer annular friction weld face, a joining plane is arranged in the region of the annular field substantially centrally between two annular grooves in the web which is located between the two annular grooves. A heat-affected zone is thereby produced directly above and directly below this joining plane. In an outward direction substantially at the height of this heat-affected zone, there is produced the friction weld bead which subsequently has to be removed from the surface of the piston so that the piston can be inserted in the cylinder of the internal combustion engine. The removal of the friction weld bead is carried out in this instance as far as the surface of the piston which subsequently has the finished dimension for the operation of the piston in the cylinder of the internal combustion engine.

An object of the invention is to improve the known piston with regard to the durability thereof.

### SUMMARY

According to the invention there is provision for the joining plane to be located between the upper flank (the plane in which the upper flank is located, including or deviating therefrom) and the lower flank (the plane in which the lower flank is located including or deviating therefrom) of the annular groove and a heat-affected zone which is produced as a result of the use of the friction welding method to include at least the upper flank and/or the lower flank of the annular groove.

With respect to the position of the joining plane and the heat-affected zone which is produced according to the prior art, the present invention relates to the fact that the heat-affected zone extends into an annular groove. This has the advantage that, during the processing of the weld beads which are produced during friction welding, not only can a processing be carried out as far as the outer surface of the cylindrical piston but instead a deeper processing is carried out in order to remove the friction weld bead and at the same time either to free an annular groove which is already present from the friction weld bead which has been introduced at that location or to introduce in the region of the heat-affected zone and where applicable also regions of the annular groove located below or above (when the piston stroke axis is considered). There is thereby advantageously carried out a hardening of the upper groove flank or the lower groove flank depending on where the joining plane is located.

It is quite particularly advantageous for the joining plane to be located substantially centrally (either precisely centrally or slightly off-center, for example, by less than or equal to 30% of the height of the annular groove) between the upper flank and the lower flank of the lowest annular groove and for the heat-affected zone which is produced to include the upper flank and lower flank of the lowest annular groove. In particular with highly loaded pistons of internal combustion engines, it has been found that the hardening of at least one groove flank, but also of both groove flanks, of the upper annular grooves (which face the cylinder space) is not sufficient. For these annular grooves, therefore, other methods for hardening are required (such as, for example, laser remelting). In this instance, therefore, the hardening by the heat-affected zone which is produced during the friction welding method is surprisingly sufficient. This generally applies with the use of any structural types of rings which are inserted into the lowest annular groove. Furthermore, it has been found that the hardening by the heat-affected zone which is produced during the friction welding method is particularly effective in the case of a three-piece oil scraper ring since thereby if at all an only very low wear of the abutting surfaces of the groove flank and oil scraper ring is produced.

The introduction of an annular groove after the joining of the upper portion and lower portion by means of the friction welding method can be carried out using at least the two methods described below.

Either the friction weld bead which is produced at the outer side is removed after the friction welding (for example, by means of a machining processing operation) so that an almost smooth piston surface is produced. Subsequently, at the location where the annular groove is intended to be located, it is produced, preferably by means of a machining processing operation using a chisel in a turning method. Substantially the central region of the heat-affected zone is thereby removed, but parts thereof remain in the region of the consequently hardened upper and/or lower flank of the annular groove. This procedure has the advantage that the tool, in particular the chisel, can be guided in a selective manner and does not extend through the irregularly shaped friction weld bead. Consequently, the dimensional stability of the plunge-cut annular groove is increased.

Or, alternatively, the friction weld bead which is present is left and removed using the tool with which the annular groove is produced. The previous step of removing the friction weld bead is thereby superfluous. However, it must be ensured that the tool, in particular the chisel, does not run off-center during the removal of the friction weld bead.

### BRIEF DESCRIPTION OF THE DRAWINGS

The invention is described in greater detail below and with reference to the Figures.

FIG. 1 is a schematic partial side view of a piston showing one example of a joining plane and heat-affected zone.

FIG. 2 is an alternate example of the piston shown in FIG. 1.

FIG. 3 is an alternate example of the piston shown in FIG. 1.

FIG. 4 is an alternate example of the piston shown in FIG. 1.

FIG. 5 is an alternate example of the piston shown in FIG. 1.

FIG. 6 is an alternate example of the piston shown in FIG. 1.

### DETAILED DESCRIPTION

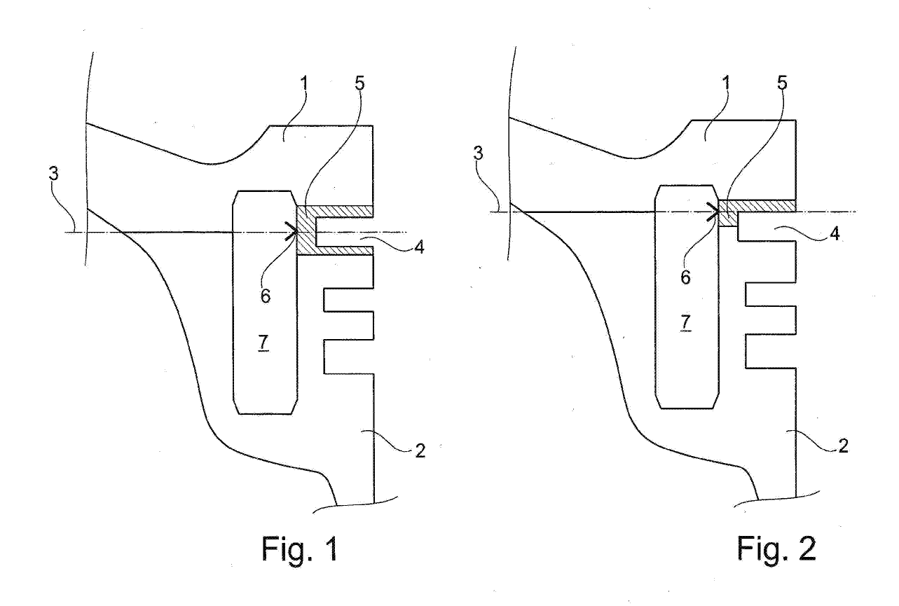

FIG. 1 shows a piston which comprises an upper portion 1 and a lower portion 2.

The construction of these two portions 1, 2 is exemplary and the invention is not limited thereto.

The two portions 1 and 2 have joining faces which face each other and which are joined together in a non-releasable manner in a joining plane 3 by means of a friction welding method.

In this embodiment, the joining plane 3 is located substantially centrally between an upper flank and a lower flank of an annular groove 4. In this instance, the position of the joining plane 3 is precisely centrally between these two flanks, wherein the position of the joining plane 3 may also be displaced from this central position upward or downward (when FIG. 1 is viewed). The joining plane 3 may even be provided in the same plane in which the upper flank or lower flank of the annular groove 4 is arranged.

As a result of the friction welding method, a heat-affected zone 5 is produced (illustrated in dark grey), wherein firstly after the joining of the two portions 1, 2 by means of the friction welding method, the annular groove 4 is not yet present. This groove is first introduced (for example, plunge-cut) into the heat-affected zone 5 which is produced by means of a suitable processing operation, for example, a machining method. The geometry (cross-section) of the annular groove 4 is in this instance selected in such a manner that it is located completely inside the heat-affected zone 5 which is produced. On the groove base of the annular groove 4 there is formed a friction weld bead 6 which is arranged in a cooling channel 7. The cooling channel 7 may, but does not have to, be formed together by the upper portion 1 and the lower portion 2. Since after the non-releasable joining of these two portions 1, 2 the inner space of the cooling channel 7 is no longer available, the friction weld bead 6 remains in this region. The friction weld bead which is produced in an outward direction is removed either by introducing the annular groove 4 or preferably beforehand in a separate step. In this embodiment, the joining plane 3 is consequently located between the upper flank and the lower flank of the annular groove 4, wherein in this specific case the joining plane 3 is located centrally between the upper flank and the lower flank of the annular groove 4. This central arrangement of the joining plane 3 may also be displaced in the direction of the upper flank or the lower flank of the annular groove 4. It is even conceivable for the joining plane 3 to be located in the plane of the upper flank of the annular groove 4 or the joining plane 3 to be located in the plane of the lower flank of the annular groove 4.

In FIG. 1, the heat-affected zone 5 which is produced includes both the upper flank and the lower flank of the annular groove 4 and extends over a specific region even further in an upward direction and in a downward direction (when viewing FIG. 1).

In the embodiment according to FIG. 2, the joining plane 3 is located in the plane of the upper flank of the annular groove 4 and the heat-affected zone 5 which is produced includes the upper flank of the annular groove 4.

The same applies alternatively if the joining plane 3 is located in the plane of the lower flank of the annular groove 4 and the heat-affected zone 5 which is produced includes the lower flank of the annular groove 4.

Whilst with the above description it has been assumed that the heat-affected zone includes at least the lower flank and/or the upper flank and furthermore other regions of the annular groove 4, the heat-affected zone 5 of course also includes the groove base as far as the internal wall of the cooling channel 7.

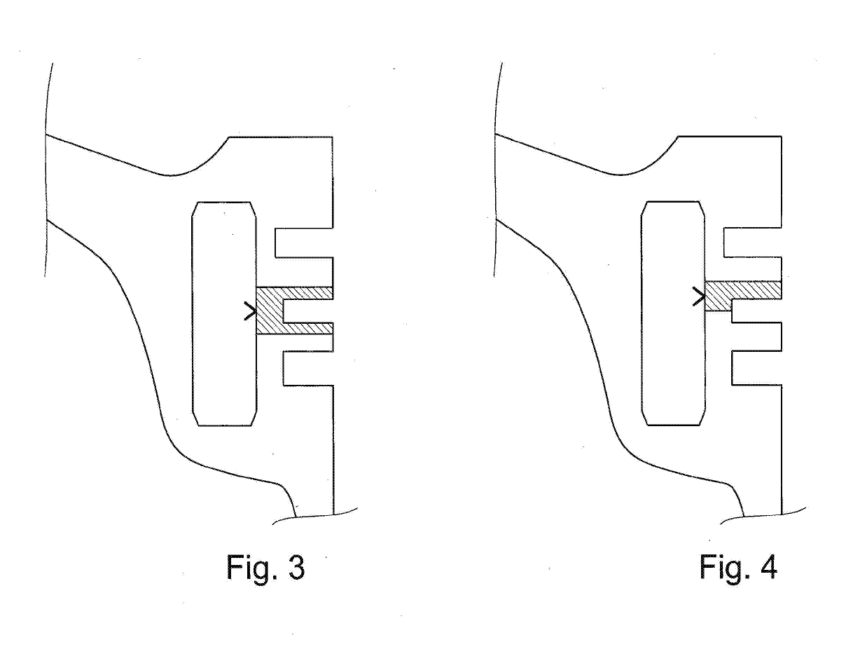

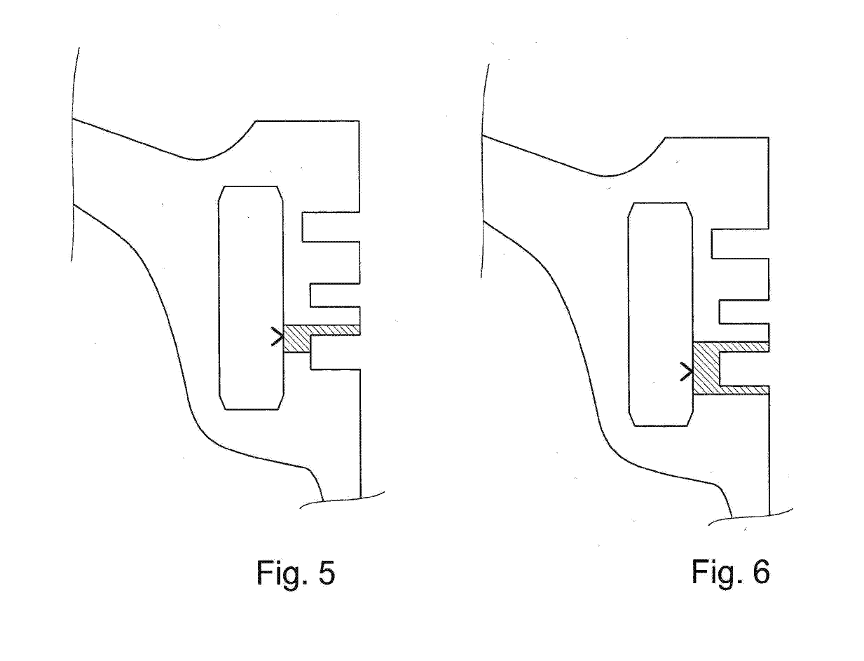

In FIGS. 3 and 4, a similar situation is illustrated to the one shown in FIGS. 1 and 2, but in this instance when the central annular groove is used. This applies in a comparable manner to FIGS. 5 (similarly to FIGS. 2 and 4) and 6 (similarly to FIGS. 1 and 3) in which the position of the joining planes and the heat-affected zones which are produced on the lowest annular groove are illustrated.

It is self-evident that a piston may have more than three or less than two annular grooves and the invention can be used not only with one annular groove but also with at least two annular grooves.

In the Figures at the top, the hardening of the second upper groove flank as a result of the friction welding is shown, wherein during friction welding the heat-affected zone (HAZ) is produced.

In FIG. 5 or 6, in particular the upper groove flank of the third (lowest) annular groove is hardened by the friction welding which is particularly advantageous with a three-part oil ring.

In the above-mentioned embodiments, depending on the construction type of the two portions 1, 2 either there is provided only a single joining plane 3 in which the joining faces of the two portions 1, 2 face each other prior to the friction welding operation and are subsequently brought together and non-releasably connected to each other, or there are provided more than one joining plane with correspondingly constructed mutually facing joining faces of the two portions 1, 2, wherein the at least two joining planes are located in the same plane or in different planes.

In these exemplary variants, to which the invention is not, however, limited, the joining plane of the external or single friction weld connection between the upper portion and lower portion is not located centrally in the web between two annular grooves (as in DE 10 2010 033 881 A1), but instead the friction weld zone and consequently the heat-affected zone extends into the annular groove and where applicable also regions located therebehind (as far as the beginning of the cooling channel).

Whilst in the two illustrations of the Figures the heat-affected zone is shown in the region of the respective upper groove flank, it can also be envisaged to provide the heat-affected zone in the region of a lower groove flank.

In any case, the heat input can advantageously be used by the friction welding process for the subsequent hardening operation.
1. Upper portion
2. Lower portion
3. Joining plane
4. Annular groove
5. Heat-affected zone

1. A piston of an internal combustion engine, comprising an upper portion and a lower portion which are joined together in a non-releasable manner in the region of a joining plane through a friction welding method, wherein the piston has at least one peripheral annular groove, characterized in that the joining plane is located between an upper flank and a lower flank of the at least one peripheral annular groove and a heat-affected zone which is produced as a result of the use of the friction welding method includes at least one of the upper flank or the lower flank of the at least one peripheral annular groove.

2. The piston as claimed in claim 1, wherein the joining plane is located centrally between the upper flank and the lower flank of the at least one peripheral annular groove, and the heat-affected zone includes the upper flank and the lower flank of the at least one peripheral annular groove.

3. The piston as claimed in claim 1, wherein the joining plane is located in a plane of the upper flank of the at least one peripheral annular groove, and the heat-affected zone includes the upper flank of the at least one peripheral annular groove.

4. The piston as claimed in claim 1, wherein the joining plane is located in a plane of the lower flank of the at least one peripheral annular groove, and the heat-affected zone includes the lower flank of the at least one peripheral annular groove.

5. The piston as claimed in claim 1, wherein the at least one peripheral annular groove comprises a lowest positioned peripheral annual groove having an upper flank and a lower flank, the joining plane is located centrally between the upper flank and the lower flank of the lowest peripheral annular groove, and the heat-affected zone includes the upper flank and the lower flank of the lowest peripheral annular groove.

6. The piston as claimed in claim 1, wherein the joining plane is located precisely centrally between the upper flank and the lower flank of the at least one peripheral annular groove.

7. The piston as claimed in claim 1, wherein the joining plane is located by less than or equal to 30% of a height of the at least one peripheral annular groove away from a center between the upper flank and the lower flank of the annular groove.

8. A piston for use in an internal combustion engine, the piston comprising:
an upper portion;
a lower portion connected to the upper portion along a joining plane through friction welding;
a peripheral annual groove having an upper flank and a lower flank, the joining plane intersecting the peripheral annual groove; and
a heat-affected zone in communication with the joining plane at the peripheral annual groove.

9. The piston of claim 8 wherein the peripheral annual groove comprises at least an upper groove and a lowest positioned groove, each groove having an upper flank and a lower flank, wherein the joining plane is positioned to intersect the lowest positioned peripheral annular groove.

10. The piston of claim 8 wherein the joining plane intersects the upper flank, and wherein the heat-affected zone further comprises the upper flank and a portion of a groove base connecting the upper flank and the lower flank.

11. The piston of claim 8 wherein the joining plane intersects the lower flank, and wherein the heat-affected zone further comprises the lower flank and a portion of a groove base connecting the upper flank and the lower flank.

12. The piston of claim 8 wherein the joining plane intersects a center of the peripheral annular groove positioned equally between the upper flank and the lower flank.

13. The piston of claim 12 wherein the heat-affected zone comprises the upper flank, the lower flank and a groove base connecting the upper and the lower flank.

14. The piston of claim 13 wherein a weld bead is generated in an area where the peripheral annular groove is formed.

15. The piston of claim 8 wherein the joining plane intersects the annular groove at a position distant from a center equally between the upper flank and the lower flank by less than or equal to 30% of a height defined between the upper flank and the lower flank.
